(19) United States
(12) Patent Application Publication
(10) Pub. No.: US 2010/0026126 A1
(43) Pub. Date: Feb. 4, 2010

(54) OUTER ROTOR-TYPE FAN MOTOR AND METHOD FOR MAGNETIZING MAGNET APPLIED THERETO

(76) Inventors: Seung-Do Han, Gyeonggi-Do (KR); Dong-Il Lee, Gyeonggi-Do (KR); Hyoun-Jeong Shin, Incheon (KR)

Correspondence Address: KED & ASSOCIATES, LLP, P.O. Box 221200, Chantilly, VA, 20153-1200, US

(21) Appl. No.: 12/442,182

(22) PCT Filed: Jul. 31, 2007
(86) PCT No.: PCT/KR07/03670

§ 371 Date: Mar. 20, 2009

(30) Foreign Application Priority Data
Sep. 21, 2006 (KR) 10-2006-0091998

(51) Int. Cl. H02K 1/27; H01F 13/00; H02K 15/03; H02K 1/02

(52) U.S. Cl. 310/156.46; 335/284; 29/598

(57) ABSTRACT

An outer rotor-type fan motor and a method for magnetizing a magnet applied thereto. The outer rotor-type fan motor comprises a rotation shaft; a stator disposed outside the rotation shaft; a fan having a hub and blades formed on the hub, the hub covering the stator with a predetermined gap; and a magnet disposed on an inner surface of the hub and spaced from the stator with a predetermined gap, wherein the magnet is an isotropic magnet magnetized to have a pole anisotropy. Accordingly, a cogging torque and noise are reduced without reducing a back-electromotive force, thereby obtaining a high efficiency.

### TECHNICAL FIELD

The present disclosure relates to an outer rotor type-fan motor and a method for magnetizing a magnet applied thereto, and more particularly, to an outer rotor type-fan motor capable of reducing a cogging torque and noise with maintaining an output performance or efficiency when being miniaturized, and a method for magnetizing a magnet applied thereto.

### BACKGROUND ART

As a fan for blowing cool air for a refrigerator, an outer rotor-type fan motor that can be made to be compact in a radial direction and a shaft direction is generally applied with consideration of an installation space inside a cooling space of the refrigerator.

FIG. 1 is a perspective view showing an outer rotor-type fan motor in accordance with the conventional art.

As shown, the conventional outer rotor-type fan motor 10 comprises: a rear bearing assembly 17 attached to a casing (not shown); a stator 12 attached to the rear bearing assembly 17; a front bearing assembly 15 attached to the stator 12; and a fan unit 20 connected with a rotation shaft 11 supported by the two bearing assemblies 15 and 17 so as to be freely rotated at a center thereof, and having a rotor yoke 13 disposed on an outer circumference of the stator 12.

More concretely, the fan unit 20 includes a fan body 21 formed of a synthetic resin and disposed at a central portion; a hub 24 formed in the fan body 21 with a cylindrical shape; a plurality of blades 22 radially disposed on an outer circumferential surface of the hub 24; a blade supporting unit 23 disposed on the blades 22; and a fan base 25 extending from the fan body 21 and disposed at an edge portion.

The rotor yoke 13 is mounted on an inner circumferential surface of the hub 24, and a permanent magnet 13a is disposed in the rotor yoke 13 with a certain gap from the stator 12. The rotation shaft 11 is fixedly coupled to a central portion inside the rotor yoke 13.

The rotor yoke 13 has a cylindrical shape of which one side is closed. As the permanent magnet 13a, a magnet having a plurality of protrusions on an inner surface thereof is used.

That is, a plurality of arc-shaped protrusions are formed on the inner surface of the permanent magnet 13a.

A motor mount 29 is disposed on an outer surface of the fan base 25, thereby supporting the outer rotor-type fan motor 10.

As the stator 12 magnetically interacts with the permanent magnet 13a, the rotor yoke 13 having the permanent magnet 13a therein rotates. At the same time, the fan body 21 and the blades 22 together rotate, each integrally formed with the hub 24 having the rotor yoke 13.

FIG. 2 is a view showing a state that a magnet applied to the outer rotor-type fan motor of FIG. 1 is mounted at a magnetizer, FIG. 3 is a view showing a state that the magnet of FIG. 1 is mounted at an outer rotor-type fan motor, and FIG. 4 is a graph showing a back-electromotive force and a cogging torque of the magnet of FIG. 1.

As shown in FIG. 2, in order to magnetize the permanent magnet 13a, the permanent magnet 13a is disposed between an outer magnetizing yoke 31 and an inner magnetizing yoke 32 of the magnetizer 30. Then, a high voltage of about 1000V is instantaneously supplied to the permanent magnet 13a for magnetization.

As shown in FIG. 3, an inner surface of the permanent magnet 13a has different curvatures and has a plurality of arc-shaped protrusions inwardly disposed towards the center, thereby having a difficulty in fabricating the permanent magnet 13a. Furthermore, since each end of teeth 12a of the stator 12 has a trapezoid shape, a magnetic flux generated from the permanent magnet 13a has a square wave to lower an output performance.

Referring to FIG. 4, a magnet of a high performance having a pole anisotropy is used to prevent a lowering of an output performance due to miniaturization of the motor. However, using the magnet of a high performance having a pole anisotrophy causes a fabrication cost and a cogging torque to be increased, the cogging torque which makes the rotor yoke and the stator of the motor move with vibration, thereby increasing noise.

Besides, both the outer magnetizing yoke 31 and the inner magnetizing yoke 32 have to be used to magnetize the permanent magnet 13a, thereby causing inconvenience.

### DISCLOSURE OF INVENTION

### Technical Problem

The present inventors recognized the drawbacks of the related art described above. Based upon such recognition, the following features have been conceived.

An object of the present disclosure is to provide an outer rotor-type fan motor capable of implementing a low noise and a high efficiency by reducing a cogging torque without lowering an output performance and a back-electromotive force.

Another object of the present disclosure is to provide an outer rotor-type fan motor capable of reducing the number of processes by directly mounting a permanent magnet at a fan not a rotor yoke.

Still another object of the present disclosure is to provide a method for magnetizing a magnet applied to an outer rotor-type fan motor, capable of implementing a pole anisotropy by using an isotropic magnet without using an outer magnetizing yoke.

### Technical Solution

To achieve these and other advantages and in accordance with the purpose of the present disclosure, as embodied and broadly described herein, there is provided an outer rotor-type fan motor, comprising: a rotation shaft; a bearing assembly that rotatably supports the rotation shaft; a stator disposed outside the bearing assembly; a fan having a hub and blades formed on the hub, the hub covering the stator with a predetermined gap and having a shaft fixing portion for fixing the rotation shaft; and a magnet disposed on an inner surface of the hub and spaced from the stator with a predetermined gap, wherein the magnet is an isotropic magnet magnetized to have a pole anisotropy.

Accordingly, a cogging torque or noise can be reduced without decreasing an output performance or an efficiency of the outer rotor-type fan motor.

Preferably, the magnet is formed so that an inner surface and an outer surface thereof may have the same curvature.

Preferably, the magnet is formed to have a cylindrical shape or a ring shape thus to simplify a fabrication process and to enhance a productivity.

The stator is provided with a plurality of protruding teeth, and each end of the teeth is formed to be round thus to implement a magnetic flux of a sinusoidal wave.

Preferably, the magnet has a thickness of 1.6 mm˜2.2 mm, in which a cogging torque is reduced and a back-electromotive force is maintained.

Since an outer magnetizing yoke is not used at the time of a magnetization process, a polarity of the magnet is formed on an inner surface of the magnet.

According to another aspect of the present invention, there is provided a method for magnetizing a magnet applied to an outer rotor-type fan motor, characterized in that an outer magnetizing yoke is not used but an inner magnetizing yoke for magnetizing an inner surface of the magnet is used.

### Advantageous Effects

As aforementioned, in the present invention, a cogging torque and noise are reduced without reducing an output performance (or efficiency) and a back-electromotive force by setting the magnet to have an optimum thickness, thereby obtaining a high efficiency.

Furthermore, the outer rotor-type fan motor is mounted at the fan without using a rotor yoke or a back yoke, thereby reducing the number of entire processes and increasing a capacity of a refrigerator to which the outer rotor-type fan motor is applied.

Besides, the permanent magnet is magnetized without an outer magnetizing yoke, thereby implementing a pole anisotropy with using a cheap isotropic magnet.

### BRIEF DESCRIPTION OF THE DRAWINGS

FIG. 1 is a perspective view showing an outer rotor-type fan motor in accordance with the conventional art;

FIG. 2 is a view showing a state that a magnet applied to the outer rotor-type fan motor of FIG. 1 is mounted at a magnetizer;

FIG. 3 is a view showing a state that the magnet of FIG. 1 is mounted at an outer rotor-type fan motor;

FIG. 4 is a graph showing a back-electromotive force and a cogging torque of the magnet of FIG. 1;

FIG. 5 is a sectional view showing an outer rotor-type fan motor according to a first embodiment of the present invention;

FIG. 6 is a view showing a state that a magnet applied to the outer rotor-type fan motor of FIG. 5 is mounted at a magnetizer;

FIG. 7 is a view showing a state that a magnet of FIG. 5 is mounted at the outer rotor-type fan motor according to the first embodiment of the present invention;

FIG. 8 is a graph showing a back-electromotive force and a cogging torque of the magnet of FIG. 5;

FIG. 9 is a graph showing each back-electromotive force of the magnets of FIGS. 1 and 5 according to a thickness;

FIG. 10 is a graph showing each cogging torque of the magnets of FIGS. 1 and 5 according to a thickness;

FIG. 11 is a graph showing a back-electromotive force and a cogging torque of the magnet of FIG. 5 according to a thickness.

### MODE FOR THE INVENTION

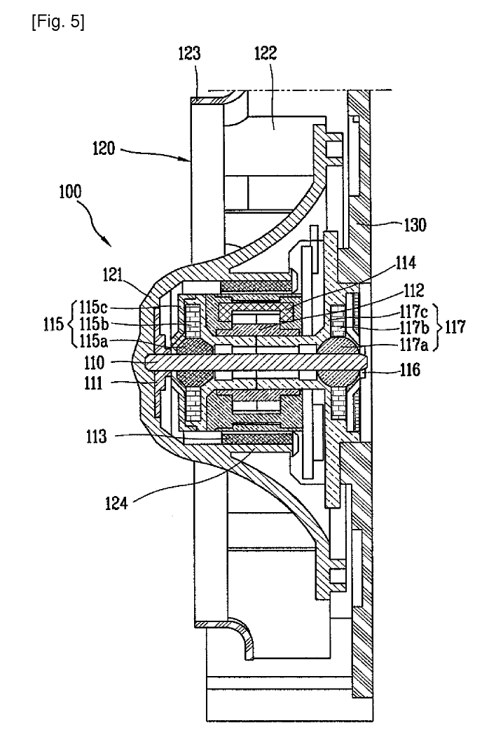

FIG. 5 is a sectional view showing an outer rotor-type fan motor according to a first embodiment of the present invention.

As shown in FIG. 5, an outer rotor-type fan motor 100 according to a first embodiment of the present invention comprises a rotation shaft 110; one pair of bearing assemblies 115 and 117 that rotatably support the rotation shaft 110; a stator 112 fixed to each outer surface of the bearing assemblies 115 and 117; a hub 124 of a fan 120 disposed outside the stator 112; a permanent magnet 113 mounted on the hub 124; and a fan body 121 having the hub 124 therein, and to which one end of the rotation shaft 110 is fixedly coupled.

The bearing assemblies 115 and 117 include bearings 115a and 117a for rotatably supporting the rotation shaft 110, and plate-shaped oil felts 115b and 117b disposed on each outer circumferential surface of the bearings 115a and 117a.

Since the oil felts 115b and 117b contain oil therein, the bearings 115a and 117a can be operated without oil. That is, oil-less bearings can be implemented.

The bearings 115a and 117a and the oil felts 115b and 117b are supported by plate-shaped bearing frames 115c and 117c, thereby forming the bearing assemblies 115 and 117.

A separation prevention ring 116 is disposed on one end of the rotation shaft 110 rotatably supported by the lower bearing assembly 117.

The stator 112 is fixedly-disposed on each outer circumferential surface of the bearing assemblies 115 and 117. A bobbin (not shown) on which a coil 114 is wound is disposed at the stator 112.

The permanent magnet 113 is disposed outside the stator 112 with a predetermined gap, and is mounted on the hub 124 of a cylindrical shape or a cup shape having one opened end and another closed end.

One end of the hub 124 is opened so that the stator 112 may be disposed in the hub 124. The rotation shaft 110 is coupled to the center of the hub 124. A disc-shaped rotation shaft base 111 is mounted on the end of the rotation shaft 110, thereby firmly fixing the rotation shaft 110 to an inner surface of the hub 124.

The permanent magnet 113 is mounted on the hub 124 with a predetermined gap from the stator 112. The permanent magnet 113 may be attached to an inner surface of the hub 124, or may be mounted in a groove (not shown) formed on the surface of the hub 124.

Since the permanent magnet 113 is directly attached onto the inner surface of the hub 124, a rotor yoke or a back yoke is not required thus to simplify an entire construction.

As the permanent magnet 113, an isotropic magnet is used to be magnetized so as to have a pole anisotropy.

A process to apply a magnetic force to a magnet is called as a magnetization. In order to perform the magnetization process, a magnetic force more than five times of a resistance-magnetic force of a material to be magnetized is required.

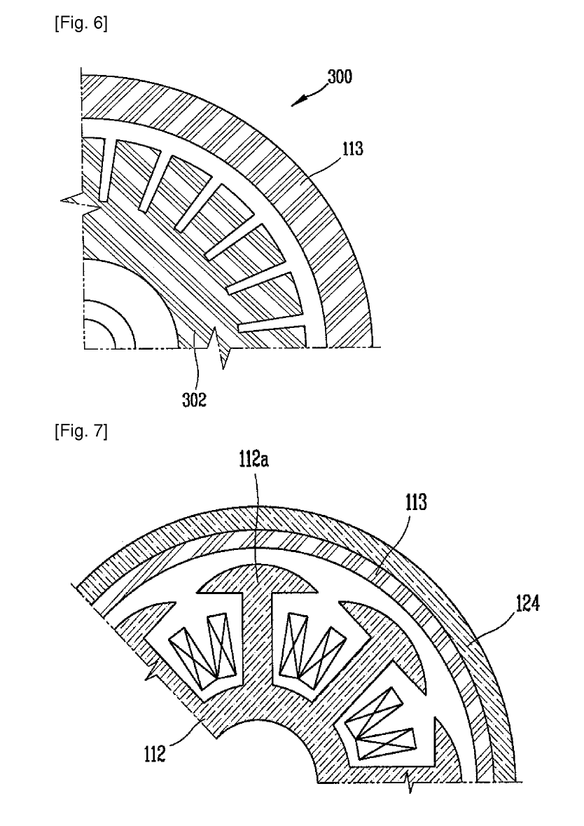

FIG. 6 is a view showing a state that a magnet applied to the outer rotor-type fan motor of FIG. 5 is mounted at a magnetizer.

As shown in FIG. 6, the permanent magnet 113 is magnetized by a magnetizer 300. The magnetizer 300 has an inner magnetizing yoke 302 disposed on an inner surface of the permanent magnet 113, but does not have an outer magnetizing yoke disposed on an outer surface of the permanent magnet 113.

Since the permanent magnet 113 is magnetized by using only the inner magnetizing yoke 302, only the inner surface of the permanent magnet 113 is magnetized. Accordingly, the permanent magnet 113 has N and S poles only on the inner surface thereof.

FIG. 7 is a view showing a state that the magnet of FIG. 5 is mounted at the outer rotor-type fan motor according to the first embodiment of the present invention.

As shown in FIG. 7, the permanent magnet 113 is formed so that an inner surface and an outer surface thereof may have the same curvature. Herein, the permanent magnet 113 may be formed to have a cylindrical shape or a ring shape, and may be formed by assembling a plurality of segments.

A plurality of teeth 112a are protruding on the stator 112, and each outer end of the teeth 112a is formed to be round. Since the end of the teeth 112a is formed to be round, a distance from the inner surface of the permanent magnet 113 having a cylindrical shape or a ring shape to the end of the teeth 112a is uniform. Accordingly, a magnetic flux has a sinusoidal wave thus to implement an output performance higher than that generated when a square wave is implemented.

The permanent magnet 113 applied to the outer rotor-type fan motor 110 is magnetized without using an outer magnetizing yoke, and is mounted on the hub 124 of the fan without a rotor yoke or a back yoke.

Without an outer magnetizing yoke and a rotor yoke (or a back yoke), the permanent magnet 113 according to the first embodiment of the present invention can implement the same back-electromotive force and output performance (efficiency) as those of the conventional magnet, and can implement a cogging torque smaller than that of the conventional magnet.

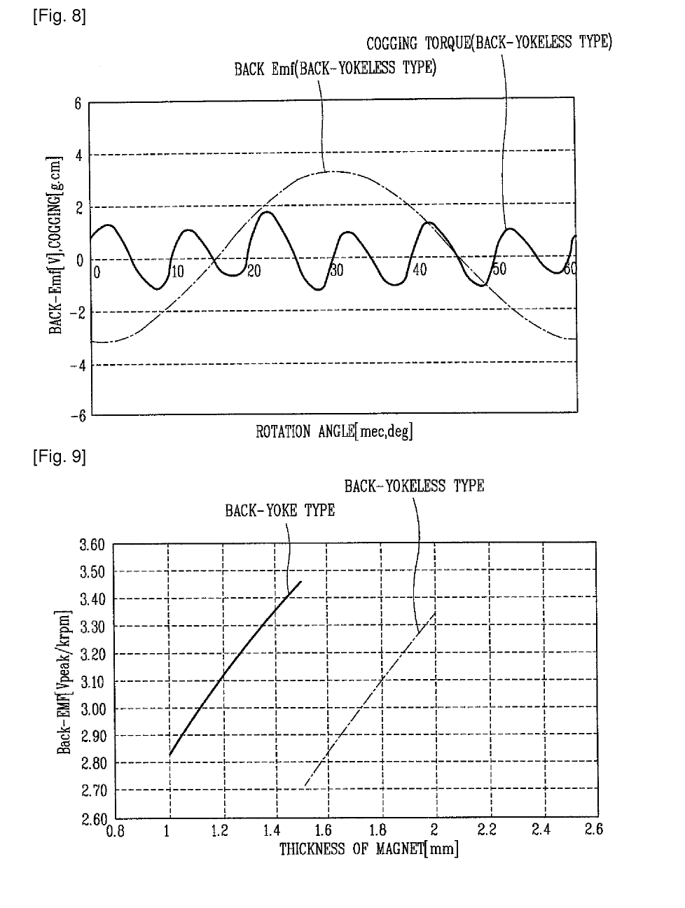

FIG. 8 is a graph showing a back-electromotive force and a cogging torque of the magnet of FIG. 5.

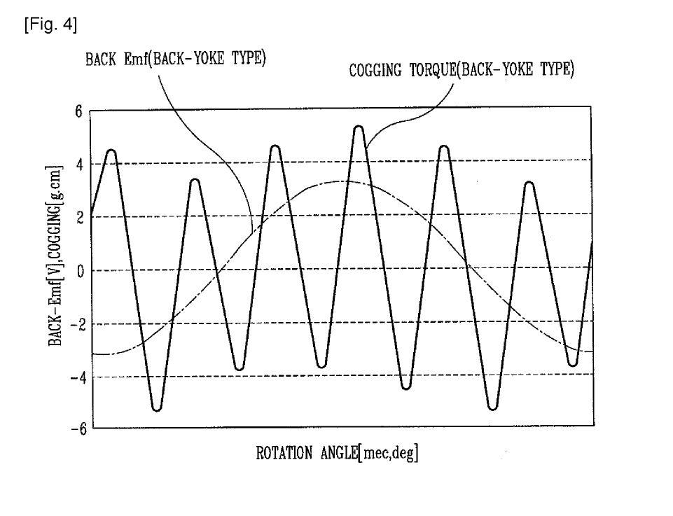

As shown in FIG. 8, a cogging torque of the permanent magnet 113 according to the first embodiment of the present invention (back-yokeless type) is much smaller than a cogging torque of the conventional magnet (back-yoke type, refer to FIG. 4).

That is, a cogging torque of the conventional magnet (back-yoke type) has a maximum value of 5 g·cm, whereas a cogging torque of the permanent magnet according to the present invention (back-yokeless type) has a maximum value of 2 g·cm which is smaller than the conventional one by more than two times.

Since the permanent magnet 113 is mounted on the outer rotor-type fan motor 100 without a rotor yoke or a back yoke, a thickness of the permanent magnet 113 has to be increased.

As the permanent magnet 113 has a thick thickness, a back-electromotive force is increased but a cogging force is varied. Accordingly, it is important to select a proper thickness of the permanent magnet 113 so as to minimize the cogging torque.

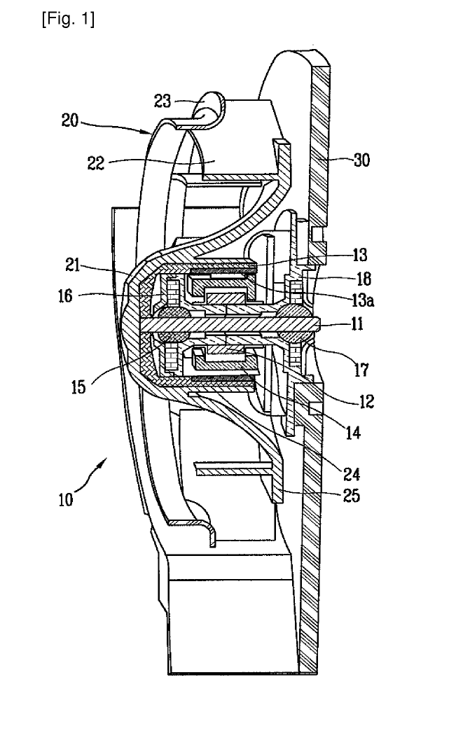

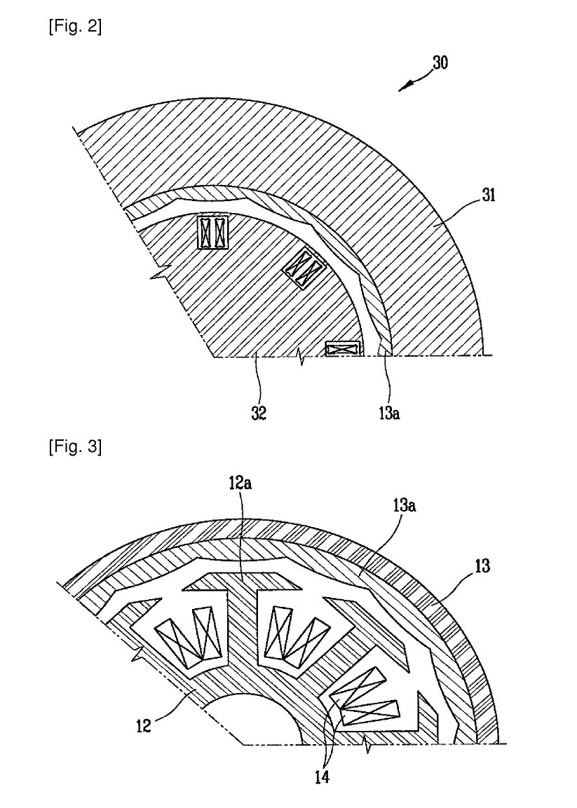

FIG. 9 is a graph showing each back-electromotive force of the magnets of FIGS. 1 and 5 according to a thickness.

As shown in FIG. 9, a back-electromotive force of the conventional magnet (back-yoke type) using a rotor yoke (or a back yoke) and having an arc on an inner surface thereof is increased when a thickness of the magnet is in a range of 1 mm˜1.5 mm. However, in the present invention (back-yokeless type), a back-electromotive force of the magnet of a cylindrical shape or a ring shape having a uniform inner surface and using no rotor yoke (or back yoke) is increased when the magnet has a thickness of 1.5 mm˜2 mm.

The conventional magnet (back-yoke type) has a back-electromotive force of 2.83 Vp/krpm˜3.48 Vp/krpm when a thickness thereof is within a range of 1 mm˜1.5 mm. However, the magnet of the present invention (back-yokeless type) has a back-electromotive force of 2.73 Vp/krpm˜3.35 Vp/krpm when a thickness thereof is within a range of 1.5 mm˜2 mm. The magnet 113 according to the present invention has nearly the same back-electromotive force as that of the conventional magnet.

A magnet applied to an outer rotor-type fan motor being currently fabricated has a back-electromotive force of 2.92 Vp/krpm. Accordingly, the magnet according to the present invention has to have a thickness enough to generate a back-electromotive force of at least 2.92 Vp/krpm.

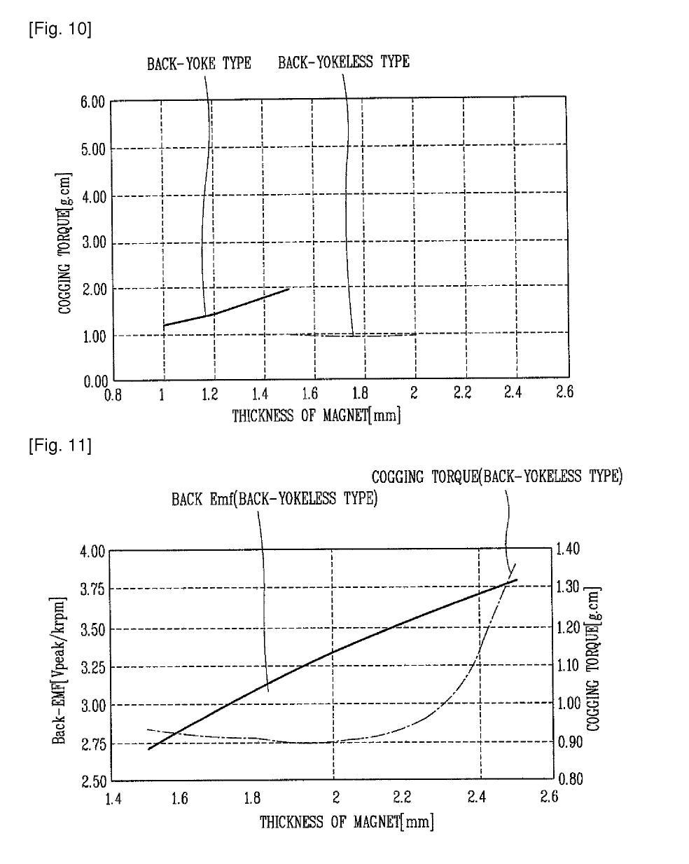

FIG. 10 is a graph showing each cogging torque of the magnets of FIGS. 1 and 5 according to a thickness.

As shown in FIG. 10, a cogging torque of the conventional magnet (back-yoke type) having a rotor yoke (or a back yoke) and having an arc on an inner surface thereof is increased when the magnet has a thickness of 1 mm˜1.5 mm. However, in the present invention (back-yokeless type), a cogging torque of the magnet of a cylindrical shape or a ring shape having a uniform inner surface and using no back yoke is almost constant when a thickness of the magnet is within a range of 1.5 mm˜2 mm.

When the conventional magnet (back-yoke type) has a thickness of 1 mm˜1.5 mm, the cogging torque is within a range of 1.0 g·cm˜2.0 g·cm. However, when the magnet according to the present invention (back-yokeless type) has a thickness of 1.5 mm˜2 mm, the cogging torque is approximately 1.0 g·cm. Accordingly, the magnet of the present invention (back-yokeless type) has a cogging torque smaller than that of the conventional magnet (back-yoke type).

According to the present invention, since the permanent magnet having a cylindrical shape or a ring shape is magnetized without using a rotor yoke (or a back yoke) nor an outer magnetizing yoke, a cogging torque thereof is smaller than that of the conventional magnet.

A magnet applied to an outer rotor-type fan motor being currently fabricated has a cogging torque of 2.77 g·cm. Accordingly, the magnet according to the present invention has to have a thickness enough to generate a cogging torque of at least 2.77 g·cm.

A thickness of the permanent magnet 113 has to be set so that the permanent magnet 113 can have a larger back-electromotive force and a smaller cogging torque than those of a magnet applied to an outer rotor-type fan motor being currently fabricated. An optimum thickness of the permanent magnet 113 is shown in FIG. 11.

FIG. 11 is a graph showing a back-electromotive force and a cogging torque of the magnet of FIG. 5 according to a thickness.

As shown in FIG. 11, the permanent magnet of the present invention (back-yokeless type) has a smallest cogging torque when a thickness thereof is within a range of 1.8 mm˜2 mm. Accordingly, it is the most preferable to set the permanent magnet to have a thickness of 1.8 mm˜2 mm.

However, the permanent magnet has a relatively smaller cogging torque when a thickness thereof is within a range of 1.6 mm˜2.2 mm. Accordingly, it is also allowed to set the permanent magnet to have a thickness of 1.6 mm˜2 mm.

A driver (not shown) for driving the outer rotor-type fan motor 100 is integrally formed with the outer rotor-type fan motor 100.

1. An outer rotor-type fan motor, comprising:
a rotation shaft;
a stator disposed outside the rotation shaft;
a fan having a hub and blades formed on the hub, the hub covering the stator with a predetermined gap; and
a magnet disposed on a surface of the hub and spaced from the stator with a predetermined gap,
wherein the magnet is an isotropic magnet magnetized to have a pole anisotropy.

2. The outer rotor-type fan motor of claim 1, wherein an inner surface and an outer surface of the magnet have the same curvature.

3. The outer rotor-type fan motor of claim 1, wherein the magnet has a cylindrical shape or a ring shape.

4. The outer rotor-type fan motor of claim 1, wherein the stator is provided with a plurality of teeth, and each end of the teeth is formed to be round.

5. The outer rotor-type fan motor of claim 1, wherein the magnet has a thickness of 1.6 mm˜2.2 mm.

6. The outer rotor-type fan motor of claim 1, wherein the magnet has a polarity on an inner surface thereof.

7. The outer rotor-type fan motor of claim 4, wherein a magnetic flux of a sinusoidal wave is formed between the magnet and the teeth.

8. The outer rotor-type fan motor of claim 4, wherein a pair of bearing assemblies for supporting the rotation shaft are disposed between the rotation shaft and the stator.

9. The outer rotor-type fan motor of claim 4, wherein a plate-shaped oil felt is disposed on an outer circumferential surface of the bearing assembly.

10. A method for magnetizing a magnet applied to an outer rotor-type fan motor, characterized in that the magnet is magnetized by a magnetizer having only an inner magnetizing yoke.

11. The method of claim 10, wherein the magnet is magnetized by using an inner magnetizing yoke for magnetizing an inner surface of the magnet without using an outer magnetizing yoke for magnetizing an outer surface of the magnet.

12. The method of claim 10, wherein the magnet has a polarity only on an inner surface thereof.
